(19) United States
(12) Patent Application Publication
(10) Pub. No.: US 2016/0247133 A1
(43) Pub. Date: Aug. 25, 2016

(54) DELIVERY-SPECIALIZED SAFE PAYMENT PROXY SYSTEM AND METHOD THEREFOR

(71) Applicant: AGARAM.COM CO., LTD., Nowon-gu, Seoul (KR)

(72) Inventor: Wang Je JO, Seoul (KR)

(21) Appl. No.: 14/902,569

(22) PCT Filed: Jul. 3, 2014
(86) PCT No.: PCT/KR2014/005973

§ 371 Date: Apr. 22, 2016

(30) Foreign Application Priority Data
Jul. 3, 2013 (KR) 10-2013-0079342

(51) Int. Cl. G06Q 20/14; G06Q 20/40; G06Q 20/20

(52) U.S. Cl. CPC G06Q 20/14; G06Q 20/20; G06Q 20/40

(57) ABSTRACT

The present invention relates to a system allowing a customer payment through a non-face-to-face method such as a telephone order or online shopping, enabling a safe payment similar to a face-to-face payment when there is a person in charge that a customer meets for a delivery or a service to the customer, transmitting a payment code to a cellular phone of the customer when simultaneously making a purchase and a temporary payment, providing the transmitted payment code to the person in charge when the delivery or the service is completed, and enabling final payment when the person in charge inputs the payment code.

### FIELD OF TECHNOLOGY

This invention is about the safety payment system providing safe agency payments at the same time of supporting convenient payment of phone order and online shopping malls.

### BACKGROUND TECHNOLOGY

Currently, as restaurants specializing in delivery through phone order and online shopping malls are expanding, stores specialized in delivery mostly receive cash payments and credit cards conduct payment through wireless card machines, and even in delivery specializing restaurants have shown food portal sites that receive order online and make payment online. Online shopping malls use bank account payment, credit card and phone payments, and each of them are introducing various security modules or security alternatives to increase the safety of payment, and Paypal and other payment agency corporations that do not need input of actual bank account number or credit card number are making efforts to increase the security of payment.

The methods of imputing actual card number and utilizing security module are generalized, and various methods to increase the security of payment have been deducted that some are actually applied, but because they are conducting payment through non face-to-face methods, the systematic limitations, leakage of information from input payment information or through hacking, hazards of unrighteous payment of third parties exists, making it clear that there are limitations compared to the on-site payments at the store.

However, considering that there are delivery personnel for shipping in online shopping malls and deliveries, payment should be made with basic online or phone order, and the final payment should be input by receiving the payment code from the customer when the shipping has been completed to minimize the hazards of online or phone payment.

### DETAILS OF INVENTION

### Technological Tasks

Thus, this invention checks the payment limits of the customer from the payment corporation to approve temporary payment to the corporation, and transmits the payment code to the customer and receives and inputs the payment code received by the customer when the corporation ships the product to the customer to make the final payment, allowing the customer to decide the last of the payment to secure safety of online or phone payment.

### Methods to Solve Tasks

The actual application will combine the aforementioned methods appropriately, and refer to the attached figures to explain in detail the methods and instruments for this invention.

FIG. 1 is the total flow chart in which the payment agency mediates the payment tasks that the payment corporation, customer and businesses form a trade contract in advance, and the payment agency forms a contract to provide agent services regarding payment procedures with the payment corporations to connect the system, and the customer conducts separate membership joining with the payment agency corporation to input wireless cellphone number, payment ID, selection of payment corporation and payment information (card number, bank account number, phone number, etc.), and the businesses conduct a separate membership signup to input payment ID, payment information (business number, affiliate code, bank account, etc.) to compose a system for payment.

To summarize membership joining content based on the credit card company, the customer signs up for card membership with the credit card corporation, and the credit card corporation searches the credibility of the customer to issue cards, and though the businesses need to select a payment agency that will conduct affiliate contract with each card corporations, but general payment agency provides an agency services for the affiliate contract of each card corporation to attribute affiliate business code, and the payment agency conducts a contract similar to VAN corporation to connect the system, and the customer joins the payment agency corporation as a member to input the card information to register it as payment method, composing the system for payment, composing the system in appropriate methods with other payment corporations.

If the customer (14) places orders to delivery specialized businesses (150) via phone or places an order at online shopping malls and require payment, the seller business (150) requests payment (102) to payment agency including customer identification number, including payment ID of the customer or phone numbers and payment amount and the payment identification information of the seller business, and the payment agency (13) utilizes the payment ID or phone number of the customer to extract information regarding the registered payment method to request payment (102) to the payment agency, and the payment agency (l30) uses the payment ID or phone number of the customer to extract information regarding the registered payment method to request payment (103) to the payment corporation (120), and the payment corporation notifies the feasibility of payment (104) if there are limitations or balances of the customer, and the payment agency transmits information to manage payment (105) that payment is possible, and transmits the payment code to the customer via message (106), and the seller business (150) prepares the order and ships (107) to receive the payment code received by the customer (108) to input the payment code into the system (109), and the payment agency checks the inserted payment code to request payment, and the payment agency checks the input payment code to request payment approval to the payment corporation if it is normal (110), and the payment corporation conducts the deduction from credit limit or transfer from bank accounts to make the final payment approval (111), and the payment agency notifies the final payment approval (112) to transmit messages regarding payment information to the customer (113) to complete payment.

Here, there is the hazard that the credit limitation and the bank account balance may differ between the time of payment approval (104) and final payment approval (111), and for these aspects, the credit card corporation or the telecommunication corporations may utilize virtual usage information to deduct limitations for a certain period, and banks may transfer the amount to virtual bank accounts of the payment agency corporation, but if the payment is not made, other payment methods or returns due to inability of payment in shipping stage that it would be the most convenient for the payment agency to take the burden of the dangers between the time, and the composition of the system may be simple, but specific composition method may be altered according to circumstances.

Also, though the concept of payment agency differs in actual life, but it encompasses the final payment corporation (12) and the corporation mediating the payment between the payment business (affiliate store) (150), and like the VAN corporation of the credit card, the role and scope of mediating card payment between the credit card corporation and the affiliate business is mall that there are a variety of company providing agency services for small shopping malls that cannot compose card payment systems to use card payment, providing agency services of payment to different businesses within a certain scope deposited by the customer by securing the function of payment company and transferring the deposited amount to the affiliate business, but the payment agency of this patent may compose all payment agency of all methods.

Also, the information needed for the joining of each services may all differ, and although there may be additionally needed information, here the minimum amount of information is being exemplified for the convenience of explanation, and the respective information transmission are conducted by the coded module, and the specific methods related to the password may differ according to the realized contents that detailed explanations will be omitted here, and the wireless cell phone (423, 517, 602) of this text refers to the cell phone that have phone call or wireless internet, and the phone order includes voice chatting without phone calls and general phone with phone numbers, and as voice chatting does not have caller ID, payment ID is utilized.

FIG. 2 is the overall flow chart in which the payment agency conducts payment agency services, and the payment corporation (220) and the customer (240) conducts in advance (A) the trade contract (contract) with the payment agency company, and the payment agency company forms a contract for the agency services regarding approval procedures and for separate affiliate store contract(C) to connect the system, and the customer conducts a separate membership joining with the payment agency company (D) to input the wireless cellphone number, payment ID, payment corporation and payment identification information (card number, bank account number and phone number), and the business (250) does not conduct additional affiliate contract with the payment corporation (220) and conducts membership joining(E) only with payment agency corporation (230) to input payment ID, composing the system for payment.

Also, though the payment procedure is similar to the FIG. 1, but differs that the payment is transferred (216) to the bank account of the seller business after being transferred to the payment agency (215) that the details may be omitted, but the seller business (25) provides services to small sized shopping malls that cannot compose its own card payment system that it had no direct relationship with the payment corporation.

FIG. 3 is the total flow chart in which the payment agency is united with the payment organization that the payment corporation (320) conducts the payment agency services as well, and is divided into the case of the telecommunication corporation conducts payment agency services when their own customer (340) has purchased from contracted seller company (350), and when the payment agency services are conducted by utilizing the deposit of the customer (various forms of E-Cash) on the affiliated company of the internet shopping mall, and the customer (340), while conducting membership joining (D) inputs the wireless cell phone number for payment and payment ID to input deposit in the account to prepare for payment, and when the corporation (350) conducts a separate membership joining (E) with the payment agency corporation, the system for payment is composed.

If the customer (340) requests payment after conducting an order at the online shopping mall, the seller company (350) requests payment to the payment agency company by including customer identification information of customers such as the payment ID or password of the customer, payment amount and the payment identification information of the seller company to request payment to the payment agency company (302), and the payment agency company uses the payment ID or phone number of the customer to check the account deposit, and if there is remaining balance, transmits the information that payment is possible to the company (305) and transmits the payment code to the customer (306) and the seller company prepares the content (350) and ships them (307) to receive the payment code transmitted to the customer (308) and inputs the payment code to the system (309) and the payment agency checks the input payment code to conduct payment transfer from the account balance of the customer, and notifies the final payment approval to the company (312) to transmit message regarding payment information (313) to the customer.

Also, when the payment company, payment agency and seller company are all provided in integrated form, the internet shopping mall is to manage the deposit of the customer (various forms of E-Cash), and does not have additional payment organizations to conduct payment in its own, and combines the examples of FIGS. 1, 2, 3 to compose payment agency of various forms, but the payment at the point in which the customer requests the first payment (302) is conducted without the financial processes of the customer, and the financial payment is made at the point of entering the received payment code (309).

FIG. 4 is the flow chart regarding the payment task of the delivery specialized corporation that if the order call to the delivery business (401) is connected to the affiliated store (402), the caller information is used to search, and if there is the information of the customer, pop-up appears automatically, and if there is no information of the customer, the information is input (403) to input order (405), and the customer may request payment in advance through phone (406), and if there is no information regarding the cell phone number registered at the payment agency connected to the prior seller company (407), whether the current caller number will be used, or whether additional information will be input is checked to input information (409), and if there is information (407), the payment method is searched on the payment agency system (408) to allow the user to select (411) if there are multiple methods (410), and if there is only one, the amount for payment and the information of the business is transmitted immediately to request payment, and the payment agency system requests approval to the payment corporation according to the payment methods registered by the customer, and when disapproval is notified by the payment company (413), the approval is notified to the business and the customer (416), and the business will request another payment method to the customer, and if it is approved by the payment company (414), the approval and payment information is transmitted to the corporation and the customer will be transmitted the payment code (415).

When the payment approval (417) is granted, the business registers (420) the transmitted payment information to the order DB of the affiliate business (421) and prints out the statement to prepare the product to deliver (422) and selects the input method of the payment code, and when utilizing the wireless cellphone of the deliverer (423), when the deliverer is selected, the number of the wireless cell phone is input automatically into the payment object of the payment agency system, and when the deliverer arrives (425) at the customer to deliver the product and then search the list waiting to be input based on the wireless cell phone of the deliverer and input the payment code (426), and if the input payment code is approved after requesting final approval to the selected payment corporation, approve, and notify disapproval if disapproved (428), and if the disapproval notification is received, the payment will be received through other payment means, and if the payment notice is normally received, the order will be finished (429), and when the deliverer is not using the wireless cell phone (423), payment information is printed (430), and the payment is checked at the time of delivery to be received (431), and the payment code is input after arriving at the business (432), and the input payment code is requested of final approval to the selected payment corporation at the payment agency system (427), and when approved, it is approved, and when disapproved, the disapproval is notified (428), and when notified of disapproval, payment will be made through other payment means after visiting, and when the payment notice is made normally, the order will be completed (433).

Also, when connected to the call center of the business, not the affiliate store (434), the order and the payment method is equal, but from the moment the order registration is completed (448), the order DB of the head office (449) and the order DB of the affiliate store (421) are linked to be processed as equally as the order of the affiliate store that additional explanations may be omitted.

Here, the payment code (426) may be numbers, letters, 1, 2 bar codes, pictures, and the methods of inputting into the wireless cell phone is through inputting through key pads, scanning or photographing or short range wireless communication, and not only one method may be applied of the above methods but multiple methods may be combined to be used, and the wireless cell phone of the deliverer may be used when registered in advance, and when through web or app extracting the number of the reader, it may be used without additional registration procedures, and the in the actual composition, the input of the payment code is possible only when the number of the wireless reader is saved on the payment agency system that the third parties cannot enter payment codes, and though the details were omitted for the direct understanding of the figure, details will be included in the explanation.

FIG. 5 is the flow chart regarding the payment tasks of the shopping mall, and after the customer logs in to the shopping mall (501), the customer selects the products (502) and requests payment (503), and when the customer has joined as member, when the customer did not register the payment ID registered in the payment agency system (504), the payment ID is input (505), when there are number of payment methods (507), the customer selects the payment method (508), and when there is only 1 (507), the amount to pay and the information of the store is transmitted to request payment (509), and the payment agency system (510) requests approval to the payment corporation according to the methods designated by the customer, and when the payment company notifies disapproval, the shopping mall and the customer is to be notified of decline, and the shopping mall will request other payment methods to the customer, and when approved by the payment corporation, at the same time as transmitting approval and payment information to the shopping mall, the customer will receive the payment code.

When the shopping mall receives payment approval (511), the transmitted payment information will be included to be registered (514) in the order DB (515) to select a corporation to ship to deliver the product to be provided to shipping corporation (516), and the shipping corporation will select a personnel to deliver the product, and when using the wireless reader of the deliverer (517), when the deliverer is selected, the number of the wireless reader is input in the payment object of the payment agent system (518), and when the deliverer reaches the customer (519) to deliver the product and searches the list of payment code waiting to be input based on the wireless reader number of the deliverer, the payment code may be entered (520), and the input payment code will request final approval to the selected payment corporation selected on the payment agency system (521), and when approved, approve, and when declined, notify decline, and when notified of decline (522) the payment would be received through other payment methods or returned (524), and when the payment notification has arrived normally (522), the order will be completed (523), and when the deliverer does not use the wireless reader (517), the payment information will be printed (526) and at the same time of the delivery, it will be received by checking the payment code (527), and the payment code will be input when arriving at the shipping corporation (528) and the input payment code will request final approval to the selected payment corporation at the payment agent system (521) to approve when approved, and notify decline when declined, and when notified of decline (529), the deliverer will visit again to receive payment through other payment means or return (531) and when the payment notification has arrived normally (529) the order will be completed (530).

However, the shopping malls and the shipping corporations generally differ that when payment is cancelled, returns will be more frequent compared to selecting other payment means, and when the shipping corporation does not use the wireless reader, it would be very convenient that it would be proper to use wireless reader, and the shipping corporation will register in the payment agent system to link with the system of the shipping corporation, and the wireless reader of the final deliverer will be used only when registered in advance, and when through web or app extracting the number of the reader, it may be used without other registration procedures, but the actual composition would allow the input of the payment code to be possible only when the wireless reader number is saved on the payment agent system that third parties cannot input code, but for the direct understanding of the figure, complicated contents will be omitted, but they will be described further in the explanations.

Also, the internet shopping mall does not use caller number but utilizes payment ID that they are explained based on the payment ID unlike delivery specialization corporation, but when searching the payment agency system, the wireless reader number may be used as key, and when the customer does not join as member in the shopping mall, the customer may select product and input the payment ID of the payment agency system or wireless reader number to request payment that the customer does not need to be a member of the shopping mall to use the payment agent system, but rather the customer needs to join in advance as the member of the payment agency system.

FIG. 6 is the task flow chart related to the payment cancellation of the customer that the customer provides payment code to the deliverer that cancellation is possible before entering the code that if the customer hopes to cancel, the customer may use the Internet to log into the payment agency system to cancel, and when using the registered wireless reader through the web or app extracting the number of the reader automatically (602), the customer may search the list waiting for the input of payment code (603) on the payment agency system (604) without additional steps to select the object of cancellation (606) and input the received payment code (607), and the payment agent system will recognize the input of the payment code of the customer as cancellation to conduct cancellation and notify the cancellation information to the seller and the customer (608).

However, the actual cancellation may be designed to prohibit the customer's cancellation, or penalties regarding the shipping costs and penalties of cancellation automatically according to the contract with the seller, and such details may be notified in advance to the customer, and in cancellation through the seller, the cancellation is very direct that additional explanations are omitted.

FIG. 7 is the flow chart of the tasks of the payment agency corporation that when there is a payment approval request from the seller (701), the approval request is made to the payment corporation requested by the customer with the information of the seller company, payment amount and the payment recognition information, and when there is no credit limits or balances in the bank account, the decline is notified, and the payment agency corporation notifies approval decline to the corporation and the customer (706), and when approved (703) payment information is registered (704) on the payment request DB (705) to transmit payment information, and after transmitting the payment code to the customer (708) the input of the payment code is waited (709), and as it is registered on the payment waiting DB, when the input time limits of the set payment code has been exceeded (710), cancellation registration (711) and the notification of cancellation to the customer is made automatically (713), and when the business notifies cancellation instead of the payment code (714), the cancellation is notified to the business and the customer (717) with cancellation registration (716), and when a normal code is input, that input by the customer (718) is recognized as request for cancellation that cancellation is notified to the company and the customer (722) with cancellation registration (720), and when the store has input payment code (718), payment approval is requested to the payment corporation (719) that when approved (723) the final step of the payment has been conducted that the actual payment influencing the customer occurs, and when the approval has been declined (723), the payment did not exist in the first place, and the information of normal payment and the payment decline is notified to the corporation and the customer.

The FIG. 9 is the payment code waiting DB structure of the payment agent corporation that it is registered at the point of requesting payment approval that it is a DB deleted at the moment of final approval request after inputting the payment code, and the input time limit is the limit of inputting the payment code that it may be set from 1 minutes to several days according to the contract with the corporation and the safety of the payment, and when the limit is exceeded, the payment is automatically cancelled, and the wireless reader number of the deliverer is the wireless reader number of the deliverer that may input the final payment code, and to judge whether it is an input of a normal payment code, it may be designated by the store, or the worker may be selected from the shipping corporation receiving the authority of the business to be input.

FIG. 10 is the example of searching and the input screen at the payment code waiting DB that it may be searched on the wireless reader of the deliverer, and when searched by the customer using the wireless reader, the information of the corporation conducting payment and the amount will be provided.

The final example is merely for an example, not to limit this invention. Though this invention was explained by referring to an actual example, but the terms used here are not for limitation but for explanation and example.

Also, as long as it does not deviate from the idea and the scope of this example, and various changes and revisions may be made within the attached scope of patent claim, and though this invention was explained by referring to specific structure, material and actual examples, this invention is not limited, and may be expanded functionally using equal structure, methods and usage within the attached patent claim scope.

### Effects of the Invention

As mentioned above, the payment code issued at the time of payment is transmitted to the customer, and when the corporation delivers the product to the customer, the payment code received by the customer is input to make the final payment, and the payment in delivery order and online order does not make the actual payment and waits, and the payment is made at the point the payment code is input that the customer may utilize phone order and online payment with satisfaction, but not provide the important information such as credit card numbers related to the payment to complete the payment.

### EXPLANATIONS OF THE FIGURES

FIG. 1 is the total flow chart in which the payment agency corporation mediates only the payment tasks.

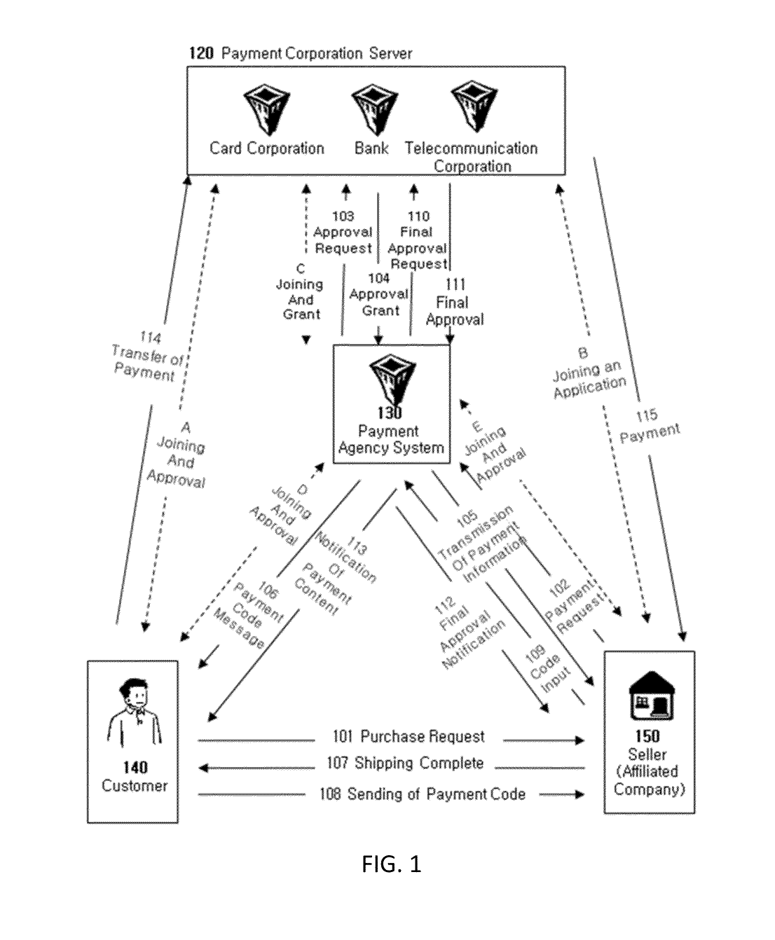

FIG. 2 is the total flow chart in which the payment agency corporation conducts payment agency tasks.

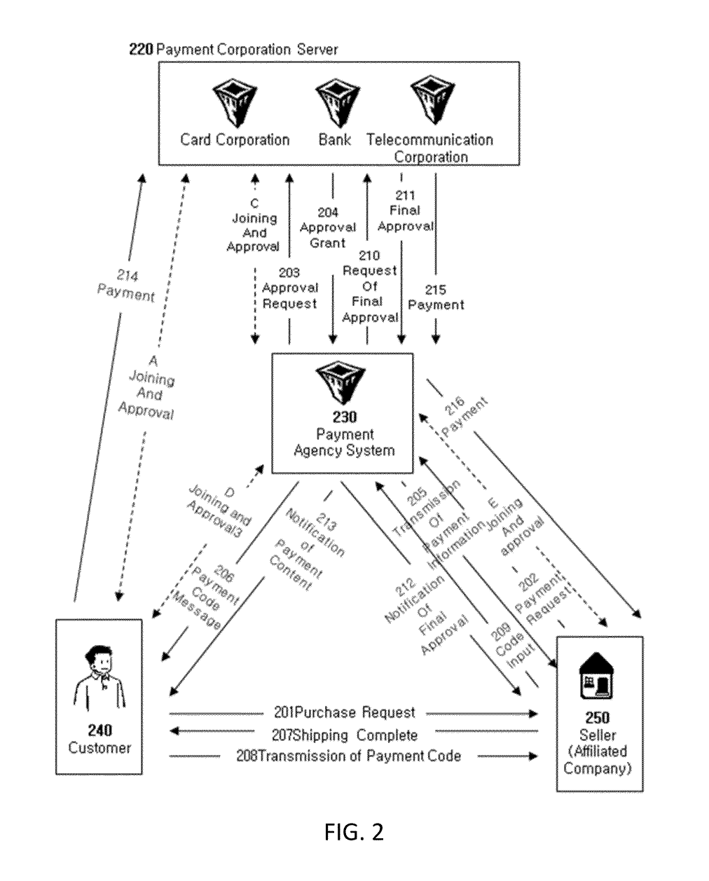

FIG. 3 is the total flow chart in which the payment agency corporation is integrated with the payment organization

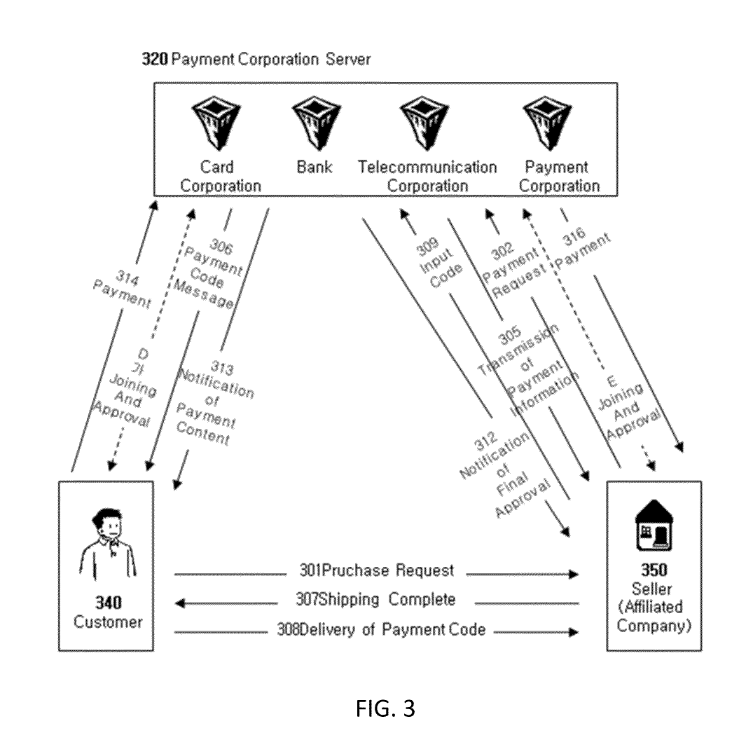

FIG. 4 is the flow chart regarding the payment tasks of the delivery corporation

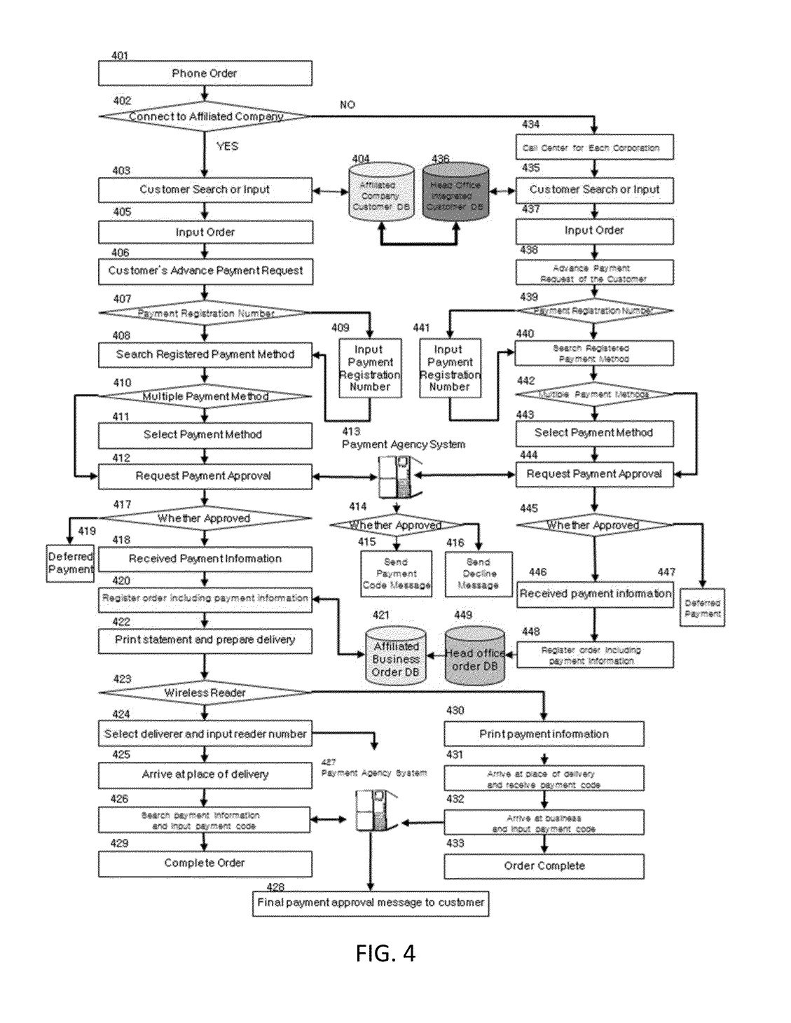

FIG. 5 is the flow chart regarding the payment tasks of the shopping mall

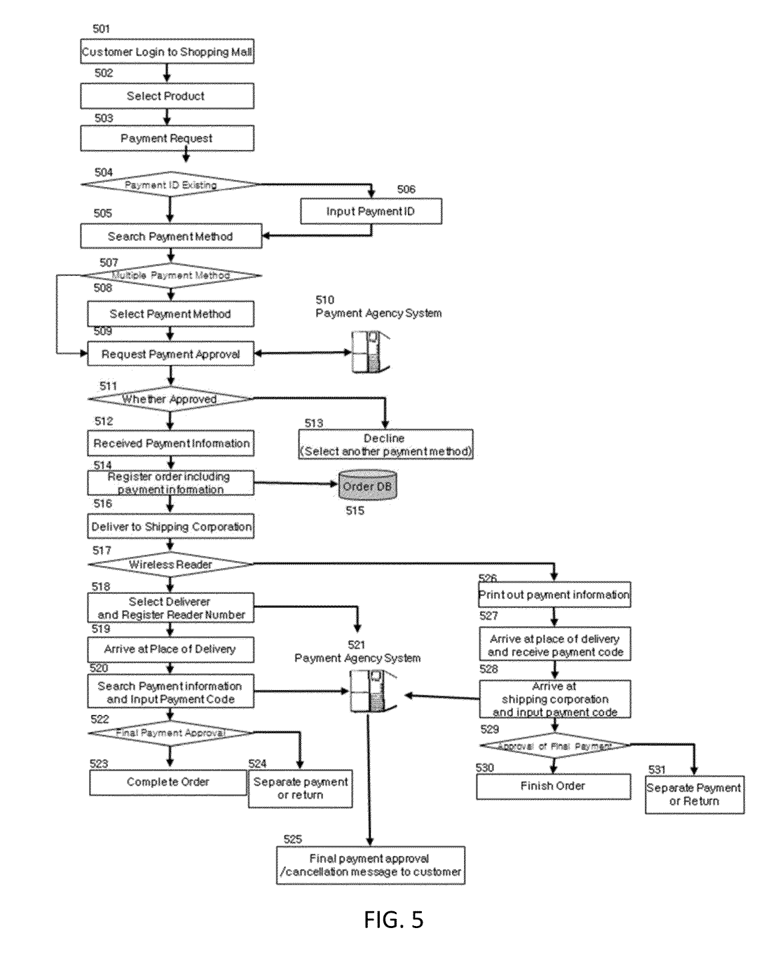

FIG. 6 is the task flow chart related to the payment cancellation of the customer

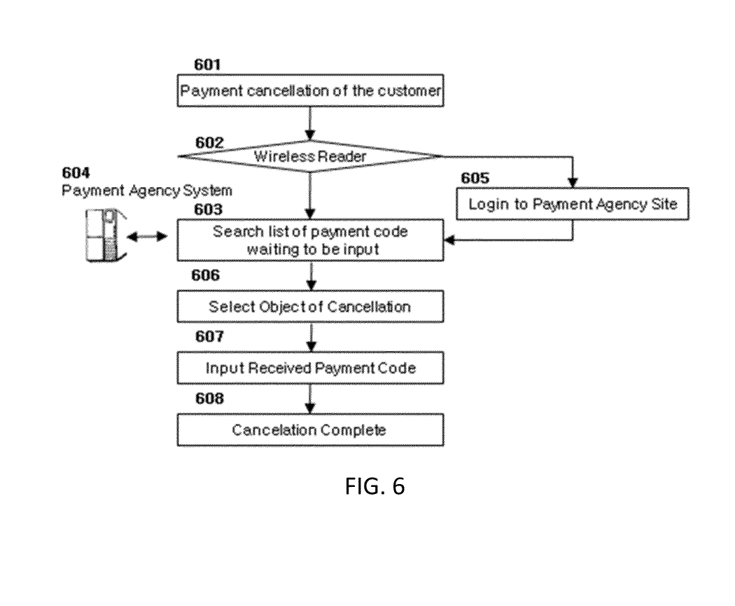

FIG. 7 is the flow chart regarding the tasks of the payment agency corporation

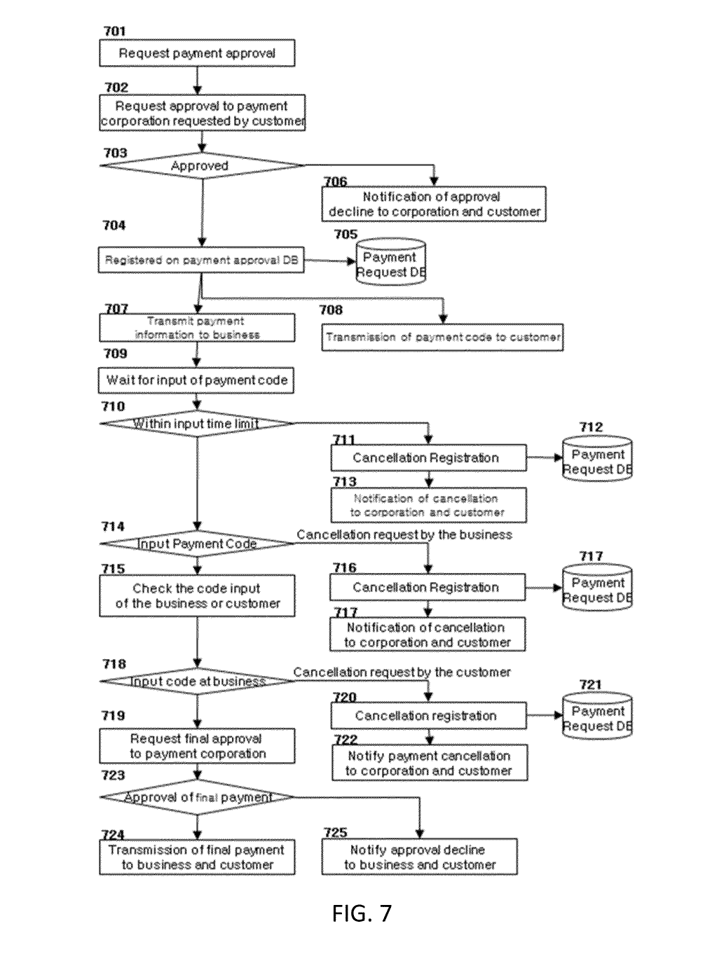

FIG. 8 is the structure of customer DB of the payment agency corporation

FIG. 9 is the structure of the payment code waiting DB of the payment agency corporation

FIG. 10 is the example of search and input screen at the payment code waiting DB

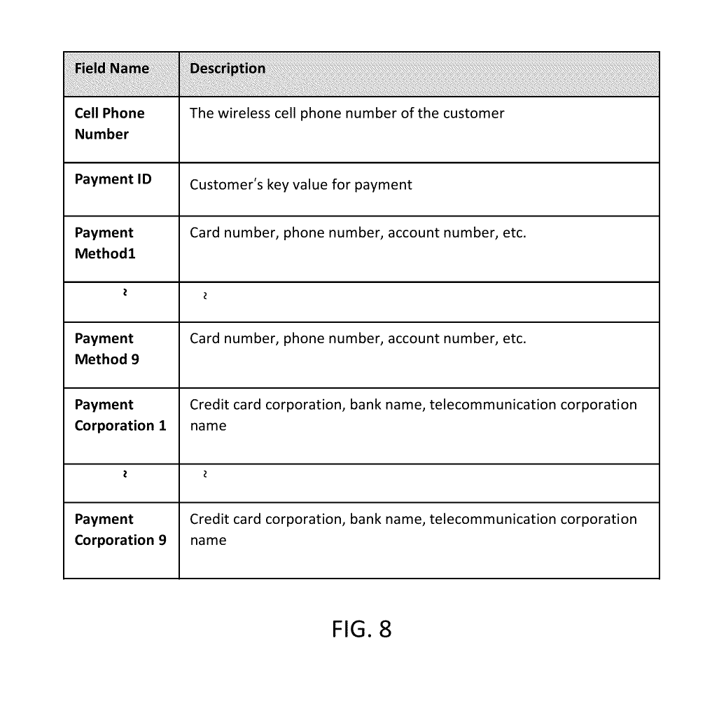

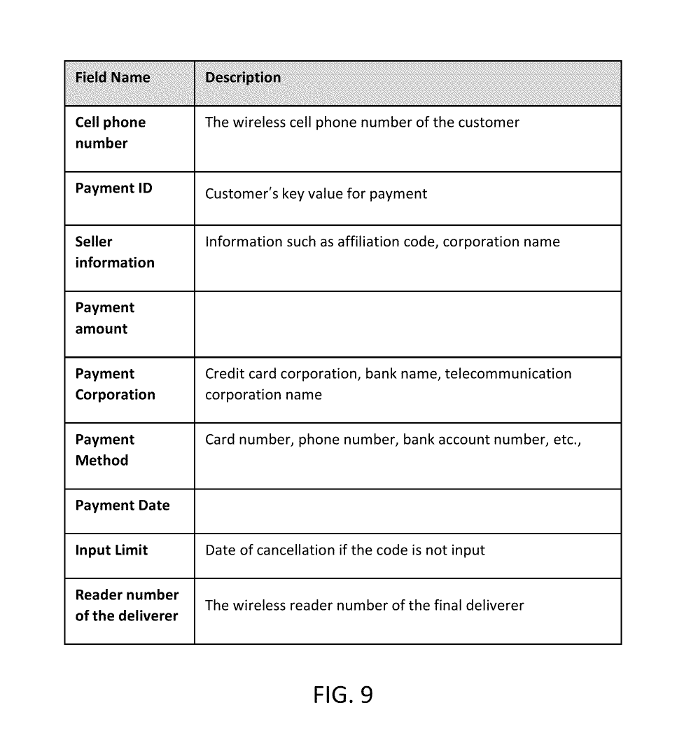

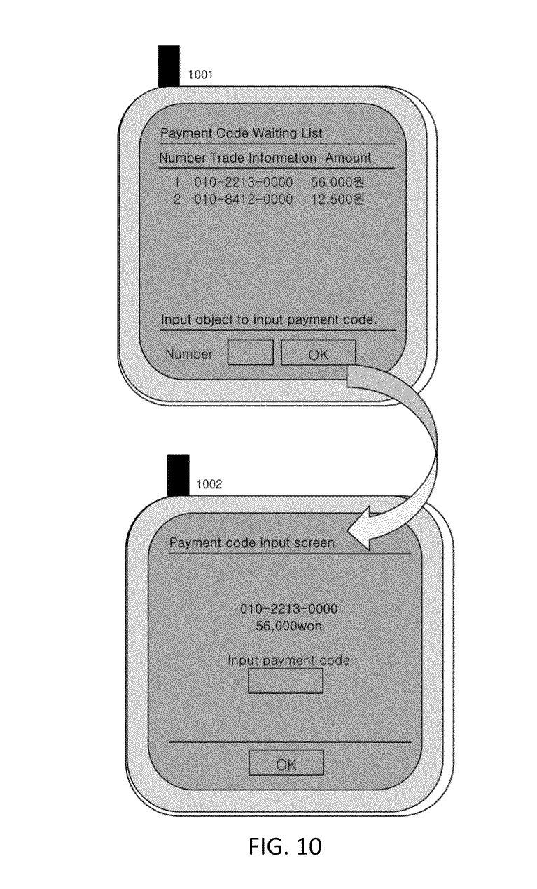

1. It relates to the system that enables safe customer's payment similar to face-to-face payment if the representative to meet the customer for the delivery or service while by the a non-face-to-face as online shopping or phone orders,
In safety settlement system, after performing tasks such as settlement system of financial and telecommunications companies, payment of the dealer in the name of the agency's billing in the payment system including settlements of credit card, debit card, bank transfer and minority carrier billing, management of the payment agency (PG) when the payment is settled by a payment (130,230), POS or shopping mall system managing of non-face-to-face telephone or online ordering for the order registration and management (150, 250), the mobile station of customer receiving a payment code, wireless terminal of the representatives entering the payment code (1001), DB to manage customer billing in safety (FIG. 8) and billing code waiting DB to manage to a temporary settlement and final payment administration (FIG. 9):
The step that POS or shopping mall system store inputted order information in the order DB (404, 502), and transmit customer ID and the order amount and payment method to the settlement system (414, 509);
The step that payment agency systems request authorization payment system in the financial and telecommunications companies including the sale of the company and the payment amount and payment identification information according to the received information (702);
The step that payment system in the financial and telecommunications companies queries customer's remaining account balance or credit limit with received information and notify refusal if the amount is less than the requested amount or authorize if the amount is more than the requested amount to the payment agency system (703);
The step that the payment agency system, if the received authorization result is approved, registers the billing information in the billing request DB (705) and then transmits the payment code to a customer (708) at the same time as sending the authorization information to the POS system or a shopping mall system (707) and, if rejected, notify the authorization refusal to POS or the shopping mall system and the customer's wireless terminal (704);
The step that POS systems or the shopping mall system transfer entered shipping or the service worker's information to payment agency system (427), and the payment agency system stores in payment request DB, At the time of delivery or the service is completed, wireless terminal of delivery staff send the terminal code to request a list waiting for payment on the payment agency system ((426, 520);
The step that payment agency system transmit information from payment request DB to the wireless terminal of the delivery staff based on the received terminal number, and the wireless terminal displays the received information (426, 520);
The step that the wireless terminal of the delivery staff transfer the billing code received from the customer for the entered order to the payment agency system ((426, 520);
The step that the payment agency system, if the received payment codes matches (715), request authorization to the payment company after querying information of sales company, payment amount and payment identification information from payment request DB (719);
The step that payment system in the financial and telecommunications companies queries customer's remaining account balance or credit limit with received information and notify refusal if the amount is less than the requested amount or authorize or make bank transfer if the amount is more than the requested amount to the payment agency system (723);
The step that the payment agency system, if the received authorization result is approved,
registers the payment complete in the billing request DB and then transmits the payment completion to a customer (724) at the same time as sending the authorization information to the POS system or a shopping mall system and, if rejected, notify the authorization refusal to POS or the shopping mall system and the customer's wireless terminal (725);
The operating method of safety payment agency system characterized POS, shopping mall system and the wireless terminal of customer display received information (429,523).

2. In claim Article 1, to prevent the hazards of the lack of the customer's credit limit or lack of credit balance,
the method of the payment system of finance and telecommunication corporations searching the remaining credit limit or account balance with the received information to decline approval when under the amount requested of payment, and deducting the limit of the credit payment and stopping the usage of the payment amount in bank transfer.

3. In claim Article 1, when the payment agency (PG) conducting payment in the name of the agency corporation integrates the payment agency system:
The step that POS or the shopping mall system stores inputted order information in the order DB (404, 502) and transfer customer ID and order amount with payment method to payment settlement system (414, 509);
The step that payment agency system request authorization including sales company information, payment amount and payment identification information to payment system in the financial and telecommunications companies according to the received information (702);
The step that payment system in the financial and telecommunications companies queries customer's remaining account balance or credit limit with received information and notify refusal if the amount is less than the requested amount or authorize or make bank transfer if the amount is more than the requested amount to the payment agency system (703);
The step that the payment agency system, if the received authorization result is approved, registers the billing information in the billing request DB (705) and then transmits the payment code to a customer (708) at the same time as sending the authorization information to the POS system or a shopping mall system (707) and, if rejected, notify the authorization refusal to POS or the shopping mall system and the customer's wireless terminal (704);
The step that POS systems or the shopping mall system transfer entered shipping or the service worker's information to payment agency system (427), and the payment agency system stores in payment request DB, At the time of delivery or the service is completed, wireless terminal of delivery staff send the terminal code to request a list waiting for payment on the payment agency system ((426, 520);
The step that the payment agency system transmit information from payment request DB to the wireless terminal of the delivery staff based on the received terminal number, and the wireless terminal displays the received information (426, 520);
The step that the wireless terminal of the delivery staff transfer the billing code received from the customer for the entered order to the payment agency system ((426, 520);
The step that the payment agency system, if the received payment codes matches (715), transfer payment complete to customer (724) at the same time transfer authorization information to POS or shopping mall system after entering payment complete in the payment request DB, and for the not matching or the due time elapsed order, query the payment information from the payment request DB and request credit cancellation or transaction cancellation to the payment system of financial and communication company (711);
The step that payment system of the financial and telecommunications companies notify to the payment agency system after performing the money transfer recover according to the information received by the customer to cancel the credit transaction or cancel (711);
The step that the payment agency system transfer cancellation complete to the customer at the same time transfer cancellation information to POS or shopping mall system after entering the received cancellation result of payment cancellation to the payment request BD (725);
The operating method of safety payment agency system characterized POS, shopping mall system and the wireless terminal of customer display received information (429,523).

4. In claim Article 1, the methods of the operation of safety payment agency system with the trait of operation through the integration of the payment agency system by the finance and telecommunication corporation

5. In the payment code input of claim Article 1 or claim Article 3, the method of operation of security payment agency system with the trait of inputting the payment code received directly in POS or shopping mall system instead of the wireless reader of the personnel.

6. In claim Article 1 or claim Article 3, the method of the operation of security payment agency system with the trait of the form of payment code enabling the selection of 1 or more in number, letters, bar code and picture.

7. In claim Article 1 or claim Article 3, the operation of safety payment agency system with the input method of the payment code in the wireless reader being one or more of keypad, scanning, photographing and wireless communication.

8. In claim Article 1 or claim Article 3, the operation of safety payment agency system with the trait of being able to utilize the caller information displayed in call orders instead of user ID.
